(19) United States
(12) Patent Application Publication
(10) Pub. No.: US 2005/0185560 A1
(43) Pub. Date: Aug. 25, 2005

(54) Multilayer optical disc

(75) Inventors: Jong Hwan Kim, Seoul (KR); Jin Hong Kim, Yongin-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/034,738

(22) Filed: Jan. 14, 2005

(30) Foreign Application Priority Data
Jan. 15, 2004 (KR) 10-2004-0002855

(51) Int. Cl. G11B 7/24

(52) U.S. Cl. 369/94; 369/283; 369/288

(57) ABSTRACT

A multilayer optical disc including a first recording layer, corresponding to a BD disc and provided with a permeable layer having a thickness of 0.1 mm, formed on one surface of the disc and a second recording layer, corresponding to an AOD disc and provided with a permeable layer having a thickness of 0.6 mm, formed on the other surface of the disc, thereby having compatibility such that the multilayer optical disc is used by optical disc drives for different optical systems.

### BACKGROUND OF THE INVENTION

1. Field of the Invention

The present invention relates to a multilayer optical disc, and more particularly to a multilayer optical disc comprising a first layer and a second layer respectively corresponding to a blue-ray disc (BD) and an advanced optical disc (AOD).

2. Description of the Related Art

Recently, recording densities of data storage media have been rapidly increased. Optical discs are used as the most universal data storage media. A recording method, which is mainly used in a system for storing data to the optical disc, is a phase change type recording method in which the state of a recording layer of the optical disc is changed using heat energy of a laser beam.

Since a phase change type optical disc is designed such that heat is rapidly diffused therein, when an optical disc recording device irradiates a laser beam to a local region of the recording layer of the phase change type optical disc to raise a temperature of the recording layer and to melt the recording layer, the recording layer melted by the raised temperature is rapidly cooled by the above structure of the disc so that amorphous marks are formed on a crystalline matrix, thereby recording data.

When the phase change type optical disc is reproduced, the data are read using a difference of reflectivities between the amorphous marks and the crystalline matrix. Further, when the recorded data are eliminated, a laser beam having a temperature slightly lower than that of the laser beam for recording data heats the recording layer, thereby converting the amorphous marks into crystalline portions.

Among the above-described phase change type optical discs, compact discs (CDs) and digital versatile discs (DVD) have been widely spread and used. Recently, an optical disc technique using a new generation blue laser has been developed. Next generation optical discs may be divided into a blue-ray disc (BD), which has been developed by Sony, Philips, and Matsushita, and an advanced optical disc (AOD), which has been developed by Toshiba and NEC.

Since the above two standards are in direct competition with each other and appear to be equally matched, an optical disc system using the blue laser, which will be put to practical use sooner or later, may use the two standards.

The two standards are not compatible with each other due to basic differences of their optical systems. For example, as shown in FIG. 1, a BD 100 employs a blue laser at a wavelength of 405 μm and an objective lens having a numerical aperture of 0.85NA, thus having a recording layer formed on a permeable layer with a thickness of 0.1 mm.

On the other hand, as shown in FIG. 2, an AOD 200 employs a blue laser at a wavelength of 405 nm and an objective lens having a numerical aperture of 0.6NA, thus having a recording layer formed on a permeable layer with a thickness of 0.6 mm. Accordingly, optical discs, which are respectively fitted into optical systems, must be separately manufactured.

Further, in case that optical disc drives for different optical systems coexist separately, the optical disc fitted into a designated one of the optical systems cannot be used by an optical disc drive for the other optical system.

### SUMMARY OF THE INVENTION

Therefore, the present invention has been made in view of the above problems, and it is an object of the present invention to provide an optical disc, which is used by optical disc drives for different optical systems.

In accordance with the present invention, the above and other objects can be accomplished by the provision of a multilayer optical disc comprising: a first layer formed on a permeable layer having a thickness of 0.1 mm formed on one surface of the disc; and a second layer formed on a permeable layer having a thickness of 0.6 mm formed on the other surface of the disc.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a conventional blue-ray disc (BD);

FIG. 2 is a schematic view of a conventional advanced optical disc (AOD);

FIG. 3 is a schematic view of a multilayer optical disc in accordance with the present invention; and

FIG. 4 is an enlarged view of the multilayer optical disc in accordance with the present invention.

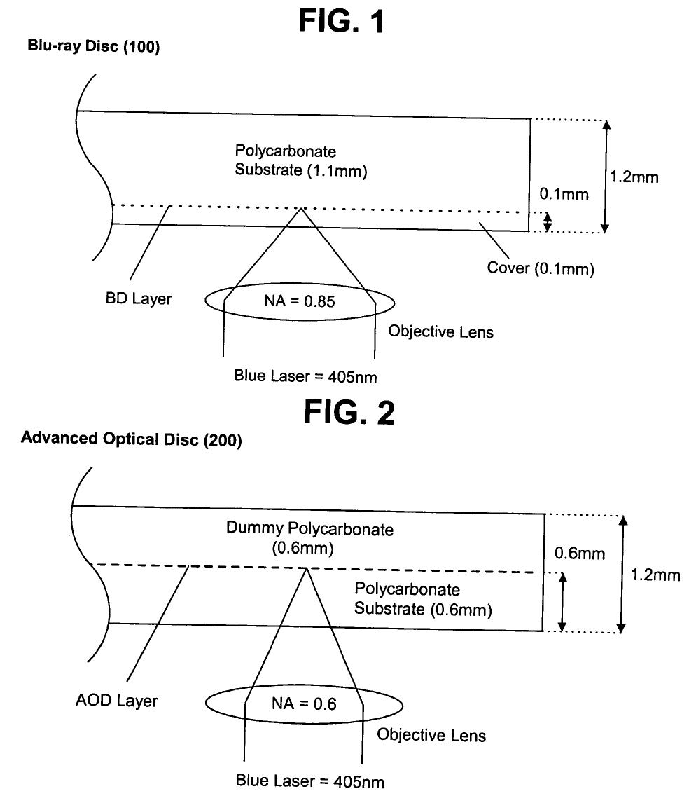

### DETAILED DESCRIPTION OF PREFFERRED EMBODIMENTS

Now, a preferred embodiment of the present invention will be described in detail with reference to the annexed drawings.

A multilayer optical disc in accordance with the present invention comprises a first recording layer provided with a permeable layer having a thickness of 0.1 mm on one surface thereof, a second recording layer provided with a permeable layer having a thickness of 0.6 mm on the other surface thereof, and a substrate with a thickness of 0.5 mm formed between the first recording layer and the second recording layer. The substrate with a thickness of 0.5 mm is attached between the first recording layer and the second recording layer using UV resin.

The first recording layer is a recording layer for the BD, which records data using a blue laser at a wavelength of 405 nm and an objective lens having a numerical aperture of 0.85NA, and the second recording layer is a recording layer for the AOD, which records data using a blue laser at a wavelength of 405 nm and an objective lens having a numerical aperture of 0.6NA.

Each of the first recording layer and the second recording layer is one selected from the group of consisting of a read only memory type recording layer, a write once read many type recording layer, and a rewritable recording layer. Hereinafter, the structure of the multilayer optical disc of the present invention will be described in detail.

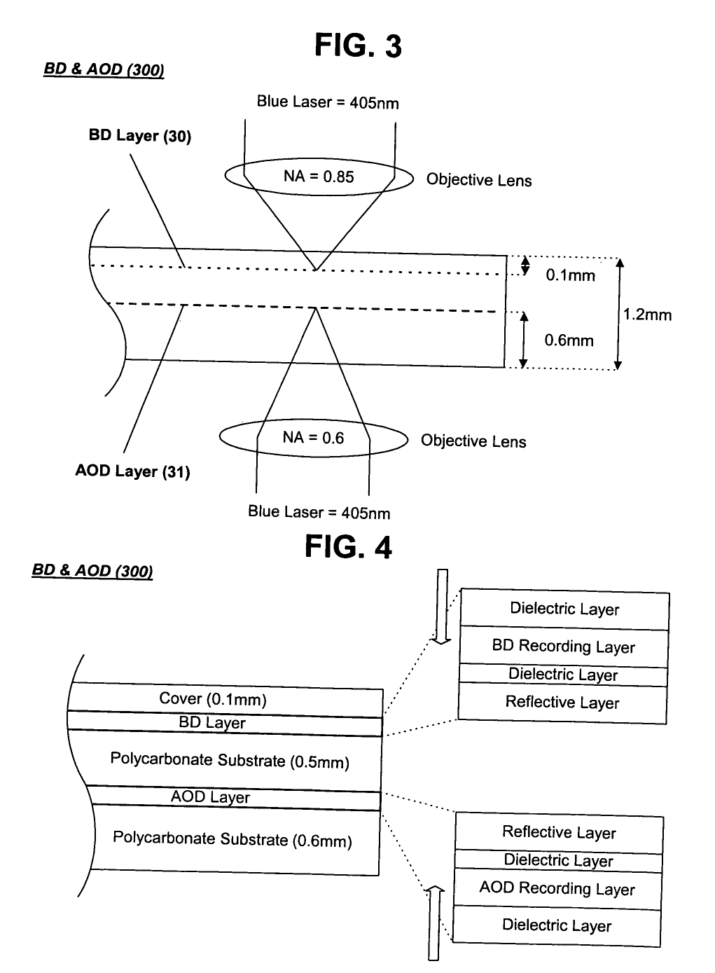

FIG. 3 illustrates the structure of a multilayer optical disc 300 of the present invention. A BD layer 30 having a permeable layer with a thickness of 0.1 mm is formed on one surface of the multilayer optical disc 300, and a AOD layer 31 having a permeable layer with a thickness of 0.6 mm is formed on the other surface of the multilayer optical disc 300.

Marks are recorded on the BD layer 30 having the permeable layer with the thickness of 0.1 mm by a BD optical system using a blue laser at a wavelength of 405 nm and an objective lens having a numerical aperture of 0.85NA, and marks are recorded on the AOD layer 31 having the permeable layer with the thickness of 0.6 mm by an AOD optical system using a blue laser at a wavelength of 405 nM and a focus lens having a numerical aperture of 0.6NA.

As shown in FIG. 4, a polycarbonate substrate with a thickness of 0.5 mm is interposed between the BD layer 30 and the AOD layer 31, which are respectively formed on the different surfaces of the multilayer optical disc 300. Here, the polycarbonate substrate is attached between the BD layer 30 and the AOD layer 31 using UV resin in an optical disc-manufacturing process.

The BD layer 30 includes a dielectric layer, a BD recording layer, a dielectric layer, and a reflective layer, which are sequentially stacked under a cover layer with a thickness of 0.1 mm. The AOD layer 31 includes a dielectric layer, an AOD recording layer, a dielectric layer, and a reflective layer, which are sequentially stacked under a polycarbonate substrate with a thickness of 0.6 mM.

As described above, the multilayer optical disc of the present invention has compatibility such that the multilayer optical disc is used by an optical disc drive provided with a BD optical system as well as an optical disc drive provided with an AOD optical system.

As apparent from the above description, the present invention provides a multilayer optical disc, which is used by optical disc drives for different optical systems.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A multilayer optical disc comprising:
a first layer formed on a permeable layer having a thickness of 0.1 mm formed on one surface of the disc; and
a second layer formed on a permeable layer having a thickness of 0.6 mm formed on the other surface of the disc.

2. The multilayer optical disc as set forth in claim 1,
wherein a substrate having a thickness of 0.5 mm is formed between the first layer and the second layer.

3. The multilayer optical disc as set forth in claim 2,
wherein the substrate having the thickness of 0.5 mm is attached between the first layer and the second layer using UV resin.

4. The multilayer optical disc as set forth in claim 1,
wherein the first layer is a high-density phase change type layer for recording or reproducing data using a laser at a wavelength of 405 nm and an objective lens having a numerical aperture of 0.85NA, and the second layer is a phase change type layer for recording or reproducing data using a laser at a wavelength of 405 nm and an objective lens having a numerical aperture of 0.6NA.

5. The multilayer optical disc as set forth in claim 1,
wherein each of the first layer and the second layer is one selected from the group of consisting of a read only memory type layer, a write once read many type layer, and a rewritable layer.

6. The multilayer optical disc as set forth in claim 1,
wherein the first layer includes a dielectric layer, a BD recording layer, a dielectric layer, and a reflective layer, which are sequentially stacked under a cover layer with a thickness of 0.1 mm, and the second layer includes a dielectric layer, an AOD recording layer, a dielectric layer, and a reflective layer, which are sequentially stacked under a polycarbonate substrate with a thickness of 0.6 mm.
